(19) United States
(12) Patent Application Publication
(10) Pub. No.: US 2022/0063145 A1
(43) Pub. Date: Mar. 3, 2022

(54) THERMOPLASTIC FUSIBLE INNER MOLD MATERIAL, INNER MOLD, METHOD FOR MANUFACTURING A HOLLOW PART

(71) Applicant: TAIWAN CHEMWELL INDUSTRIAL CO., LTD., Changhua County (TW)

(72) Inventors: FENG-MAO HUANG, Changhua County (TW); JEAN-SHYAN WANG, Changhua County (TW); SHIN-HUNG CHEN, Changhua County (TW)

(21) Appl. No.: 17/460,917

(22) Filed: Aug. 30, 2021

(30) Foreign Application Priority Data
Sep. 1, 2020 (TW) 109129953

(51) Int. Cl. B29C 33/52; C08K 5/01; C08K 3/22; C08K 3/34; B29C 33/76

(52) U.S. Cl. CPC B29C 33/52; C08K 5/01; C08K 3/22; C08K 3/34; B29C 33/76; B29K 2995/0041; C08K 2201/014; B29K 2823/0633; B29K 2995/0013; B29K 2909/00; C08K 2003/2227

(57) ABSTRACT

A material of thermoplastic fusible inner mold is provided, including: a high crystalline polymeric material and a lubricant material, the high crystalline polymeric material mixed with the lubricant material. An inner mold is further provided, made of the material of thermoplastic fusible inner mold described above. A method for manufacturing hollow part is further provided, including the following steps of: providing the inner mold; covering the inner mold with a part material; heating the inner mold which is covered with the part material to form the part material; and heating the inner mold covered with the part material which is formed at a predetermined temperature to melt the inner mold out of the part material which is formed to form the hollow part.

### BACKGROUND OF THE INVENTION

### Field of the Invention

The present invention relates to a thermoplastic fusible inner mold material, an inner mold, a method for manufacturing a hollow part.

### Description of the Prior Art

In general, composite material hollow parts are used in major industries, such as a bicycle industry, a fitness equipment industry, and parts of vehicle. However, the composite material hollow parts are generally produced through the hollow blow molding. The hollow parts formed by the hollow blow molding have a low performance, a heavy weight, and a weak structural strength. As the technology of the composite material become increasingly mature, the requirements for energy saving and product performance are gradually increasing, and the ultimate performance of lightweight is also a major trend in the development of composite materials area. The aerospace industry and the advanced bike industry especially need high standard of lightweight. Thus, the high quality of lightweight composite hollow parts are urgently needed by the market. The advanced hollow parts usually require an inner mold as an internal support member during molding. When the advanced hollow parts are formed, the inner mold is removed. The conventional inner mold is made of gypsum, wood, metal, foam material, etc. The conventional inner mold is used for forming simple configurations and parts with large openings. When the inner mold is used for forming parts with complicated structure, the inner mold is not easy to demold from the parts. Thus, it requires consuming a large amount of manpower and cost for demolding the inner mold from the part, or directly keeping the inner mold within the parts. As a result, it causes the magnitude of the cost to increase and is not much help in lightweight. In the high-end market, it develops towards soluble inner molds. The earliest soluble inner mold disclosed in patent of Switzerland by L.MARGOT in 1943. The earliest soluble inner mold is formed by pouring molten inorganic salt (K2CO3) in pouring process. Subsequently, many countries in the world, especially Japan, do an extensive research for method of manufacturing the soluble inner mold, and extend the soluble inner mold to chloride system, silicate system, carbonate system, borate system, phosphate system, etc. The urea mold core, polyethylene glycol mold core, polyvinyl alcohol mold core, etc. are used for manufacturing the wax mold at a later period. However, the conventional soluble inner mold has some shortcomings such as high price materials, hard production of the inner mold, high water absorption mineral salt mold core, so that the market cannot use it in large quantities. Thus, it is hard to preserve and cannot be used in high humidity area because of the mineral salt mold core is easy to absorb water. The inorganic polymer mold core takes long time to dissolve, so that it is hard to produce in large quantities, not easy to use for post-processing technology, with insufficient heat resistance, etc. Therefore, it causes the manufacture cost of the composite material hollow parts substantially to increase. It only provides for the aerospace industry with high unit price.

The present invention is, therefore, arisen to obviate or at least mitigate the above-mentioned disadvantages.

### SUMMARY OF THE INVENTION

The main object of the present invention is to provide a thermoplastic fusible inner mold material, inner mold, method for manufacturing a hollow part which is non-toxic, recycled, easy production, quick forming, and does not irritate the skin and also does not release toxic gas during thermal decomposition, has an excellent high-temperature fluidity.

To achieve the above and other objects, a thermoplastic fusible inner mold material is provided, including: a high crystalline polymeric material and a lubricant material, the high crystalline polymeric material mixed with the lubricant material; wherein the lubricant material is evenly distributed within the high crystalline polymeric material.

To achieve the above and other objects, an inner mold is further provided, which is made of the thermoplastic fusible inner mold material described above.

To achieve the above and other objects, a method for manufacturing a hollow part is further provided by the inner mold mentioned above, including following steps of: providing the inner mold; covering the inner mold with a part material; heating the inner mold which is covered with the part material to form the part material; and heating the inner mold covered with the part material which is formed at a predetermined temperature to melt the inner mold out of the part material which is formed to form the hollow part; wherein a melting point of the inner mold is lower than a melting point of the part material.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of an inner mold of a preferable embodiment of the present invention;

FIG. 2 is a schematic diagram of a kneading and granulation of the preferable embodiment of the present invention;

FIG. 3 is a schematic diagram of an injection molding of the preferable embodiment of the present invention;

FIGS. 4 to 6 are schematic diagrams showing the steps of manufacturing a hollow part of the preferable embodiment of the present invention; and

FIG. 7 is a flowchart showing manufacturing the hollow part of the preferable embodiment of the present invention.

### DETAILED DESCRIPTION OF THE PREFERRED EMBODIMENTS

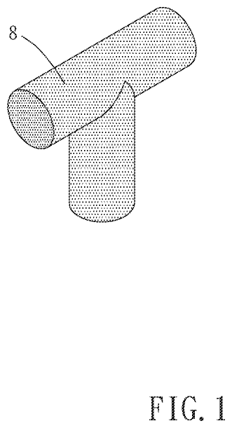

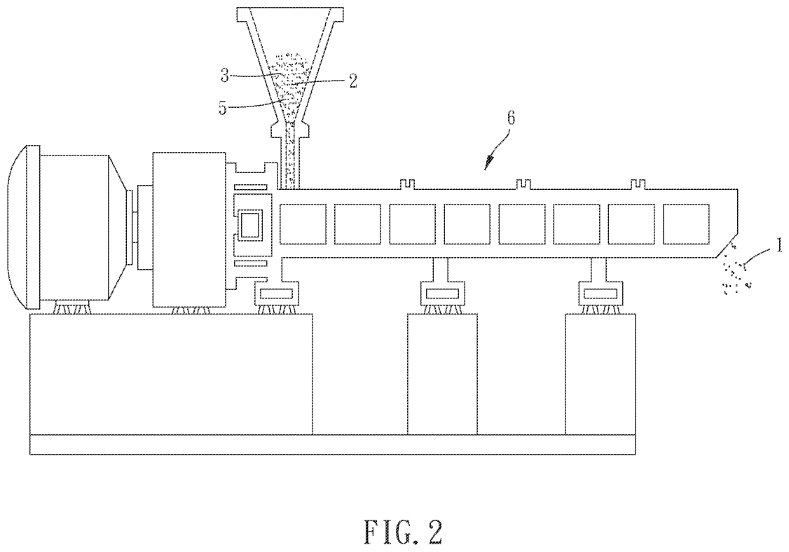

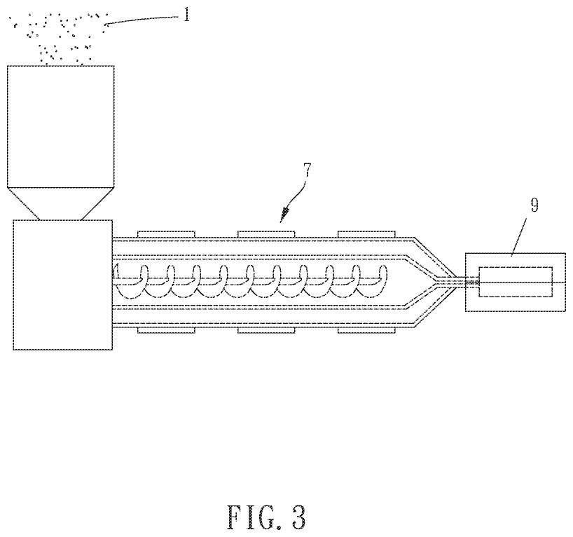

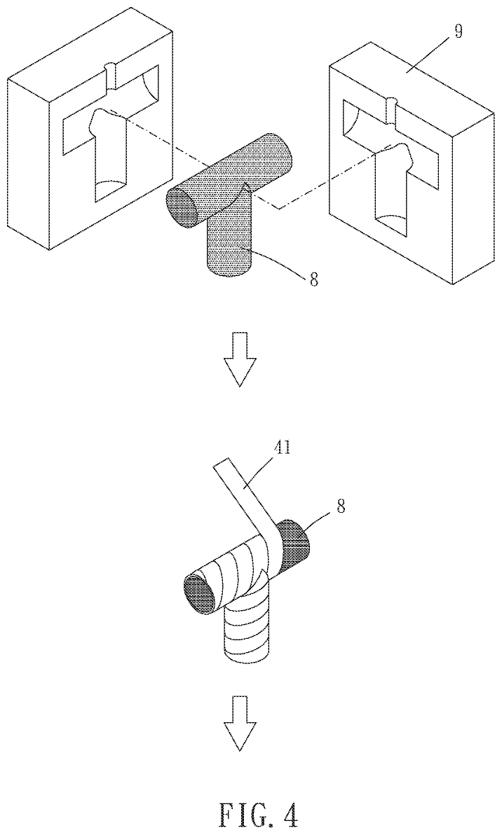

Please refer to FIGS. 1 to 7 for a preferable embodiment of the present invention. A thermoplastic fusible inner mold material 1 of the present invention includes a high crystalline polymeric material 2 and a lubricant material 3.

The high crystalline polymeric material 2 is mixed with the lubricant material 3. The lubricant material 3 is evenly distributed within the high crystalline polymeric material 2. The thermoplastic fusible inner mold material 1 is heated and melted at a predetermined temperature, and the predetermined temperature is higher than 100.00° C. The high crystalline polymeric material 2 includes at least one of polyethylene terephthalate (PET), polyoxymethylene (POM), polypropylene (PP), polyethylene (PE) and polylactic acid (PLA). The high crystalline polymeric material 2 is a polymeric material which is easy to crystallize. Preferably, the high crystalline polymeric material 2 is low density polyethylene (LEPD). The lubricant material 3 includes at least one of fatty acid, ester, metallic soap, stearic acid, zinc stearate, paraffin wax, hydrocarbon and amides. The high crystalline polymeric material 2 has excellent high-temperature fluidity, so that a product (such as an inner mold 8) made of the thermoplastic fusible inner mold material 1 has excellent high-temperature fluidity. Moreover, a demolding temperature of the thermoplastic fusible inner mold material 1 is determined on the high crystalline polymeric material 2 and a demolding efficiency is determined on the lubricant material 3, so as to improve a fluidity of the high crystalline polymeric material 2. Therefore, the product made of the thermoplastic fusible inner mold material 1 provides high-temperature fluidity through the high crystalline polymeric material 2, so that the product is melted out from the hollow part 4 which is covered on the product (the inner mold 8) at a predetermined high temperature (such as the predetermined temperature) without adhering any residue substances. That is, a viscosity of the product made of the thermoplastic fusible inner mold material 1 drops dramatically at the predetermined temperature. Thus, the thermoplastic fusible inner mold material 1 and the inner mold 8 which is made of the thermoplastic fusible inner mold material 1 are non-toxic, recycled, easy production, quick forming, environment friendly, easy for mass manufacturing, harmless of employees, do not irritate the skin, and do not release toxic gas during thermal decomposition.

The thermoplastic fusible inner mold material 1 includes 0.20% to 99.80% by weight of the high crystalline polymeric material 2, and 0.20% to 99.80% by weight of the lubricant material 3, so that the thermoplastic fusible inner mold material 1 has high-temperature fluidity. The lubricant material 3 can be particles or powder. Preferably, the lubricant material 3 is the particles, so that the lubricant material 3 and the high crystalline polymeric material 2 which is also particles can be evenly mixed with each other and is easy to manufacture. The thermoplastic fusible inner mold material 1 includes 20.00% to 80.00% by weight of the high crystalline polymeric material 2, and 20.00% to 80.00% by weight of the lubricant material 3 when the lubricant material 3 is the particles. Thus, the relative relationship between the polarities of the high crystalline polymeric material 2 and the lubricant material 3 is matched, so as to improve a volume of use of the lubricant material 3. For example, the volume of use of the lubricant material 3 can be increased to greater than 60.00 wt % and a volume of use of the high crystalline polymeric material 2 can be relatively decreased. The lubricant material 3 is evenly distributed within the high crystalline polymeric material 2, so that the thermoplastic fusible inner mold material 1 has an excellent consistency and the excellent high-temperature fluidity. Furthermore, it can shorten the dissolution time and demolding time of the inner mold 8 which is made of the thermoplastic fusible inner mold material 1.

Preferably, the high crystalline polymeric material 2 is polypropylene, polyethylene or mixture thereof, the lubricant material 3 is paraffin wax, amides or mixture thereof. The lubricant material 3 is paraffin wax, amides or mixture thereof.

The thermoplastic fusible inner mold material 1 further includes a function filler 5. The function filler 5 includes at least one of quartz powder, thermal conductive powder, foaming agent, reinforcement fiber, aluminium oxide, talc powder and peroxide. The thermoplastic fusible inner mold material 1 can be added the function filler 5 according to functional needs. The function filler 5 includes talc powder, thermal conductive powder and aluminium oxide. In this embodiment, the function filler 5 includes quartz powder, thermal conductive powder, foaming agent, reinforcement fiber, aluminium oxide, talc powder and peroxide, so that the thermoplastic fusible inner mold material 1 has good stability, good fluidity, and is lightweight, easy to pyrolysis, and easy to reach the temperature. Moreover, the thermoplastic fusible inner mold material 1 includes 30.00% to 99.60% by weight of high crystalline polymeric material 2, 0.20% to 20.00% by weight of the lubricant material 3, and 0.20% to 60.00% by weight of the function filler 5.

The thermoplastic fusible inner mold material 1 is a plurality of thermoplastic fusible particles, and the plurality of thermoplastic fusible particles are kneaded and granulated mixture of the high crystalline polymeric material 2 and the lubricant material 3 through a pelletizer 6. Thus, the thermoplastic fusible inner mold material 1 is easy to melt, and the thermoplastic fusible inner mold material 1 which is melted forms an inner mold 8 by injecting into the mold through an injection molding machine 7.

The present invention further provides an inner mold 8 made of the thermoplastic fusible inner mold material 1 as described above. A melting temperature of the inner mold 8 is higher than 100.00° C. Preferably, the inner mold 8 is produced by injecting the thermoplastic fusible inner mold material 1 which is heated and melted into a mold cavity, the inner mold 8 is adapted for being covered with a part material 41, and a melting point of the inner mold 8 is lower than a melting point of the part material 41. The inner mold 8 is heated and melted so as to demold from the hollow part 4 which is formed by part material 41. Therefore, it is easy to facilitate the high volume production of the inner mold 8, so as to improve the production efficiency and quality, and also to reduce the production costs. Furthermore, the inner mold 8 is a precision product and has a smooth surface through an injection molding process.

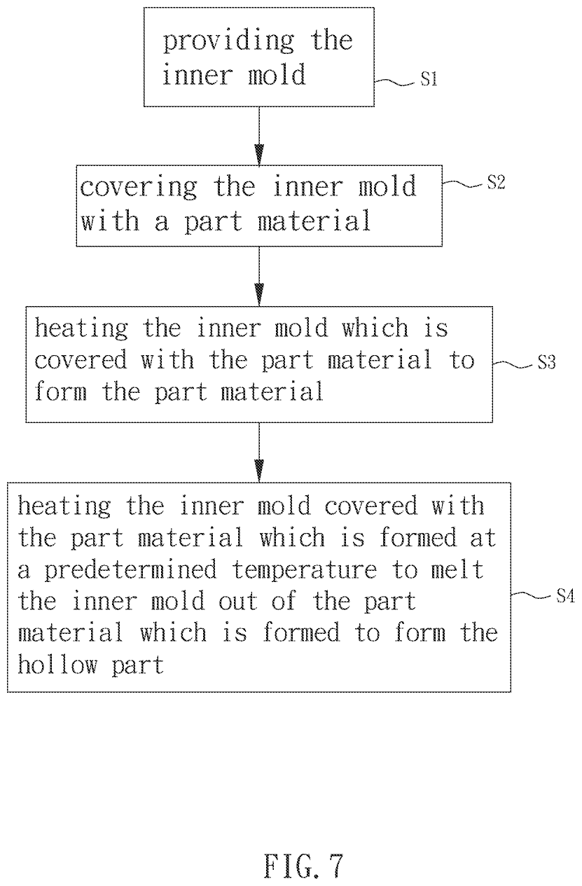

Please refer to FIG. 7. The present invention further provides a method for manufacturing a hollow part by the inner mold 8 as described above. The method for manufacturing a hollow part includes following steps.

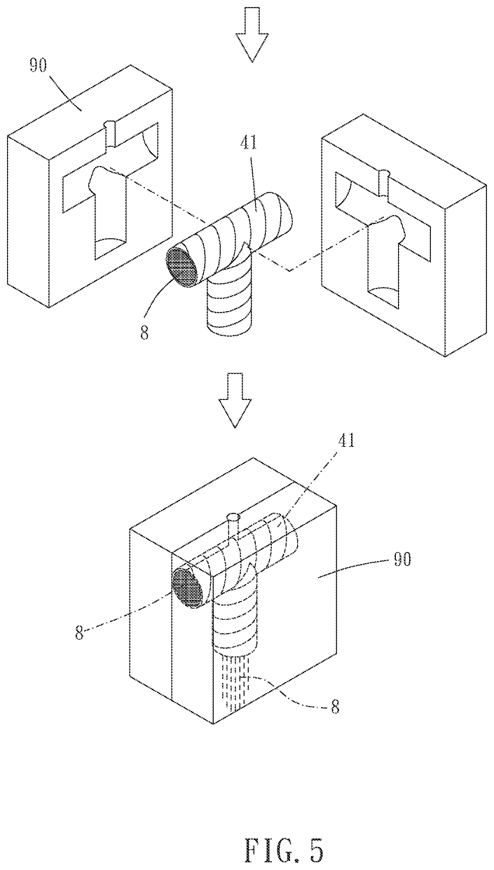

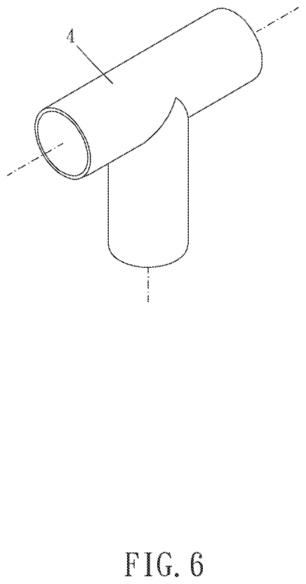

Step S1: providing the inner mold 8; step S2: covering the inner mold 8 with a part material 41; step S3: heating the inner mold 8 which is covered with the part material 41 to form the part material 41; step S4: heating the inner mold 8 covered with the part material 41 which is formed at the predetermined temperature (the predetermined temperature is higher than 100.00° C. as described above, preferably the predetermined temperature is higher than 170.00° C.) to melt the inner mold 8 out of the part material 41 (as shown in FIG. 5) which is formed to form the hollow part 4 (as shown in FIG. 6); wherein a melting point of the inner mold 8 is lower than a melting point of the part material 41. Thus, it is easy to produce the hollow part 4. And the lubricant material 3 is provides the high-temperature fluidity of the thermoplastic fusible inner mold material 1, so as to dramatically reduce the viscosity of the thermoplastic fusible inner mold material 1 at the predetermined temperature and to shorten the dissolution time and the demolding time of the inner mold 8, so as to shorten the production time of the hollow part 4. Specifically, the inner mold 8 fast demolds from the hollow part 4.

It is to be noted that the hollow part 4 with complicated structure, special-shape, or very small structure can also be easy produced and effective filled evenly. Besides, the inner mold 8 which is melted and demolds from the hollow part 4 can be recycled and re-granulated.

In order to specifically understand the technical features and functions of present invention, and implement the present invention according to the specification, so that the prefer embodiments are further provided, and the detailed description is as described below.

### First Embodiment

Step 1: Mixing 1.00 kg of the polypropylene (the high crystalline polymeric material 2) with 50.00 g of the paraffin wax (the lubricant material 3) and stirring; kneading and granulating the mixture of the polypropylene and the paraffin wax in a twin screw pelletizer machine to produce particles; the temperature is set at 170° C./175° C./180° C./185° C./185° C./180° C./175° C. in the kneading and granulation process; drying the particles to produce the plurality of thermoplastic fusible particles; and melting the plurality of thermoplastic fusible particles in the injection molding machine 7 and then injecting the plurality of thermoplastic fusible particles which are melted into a mold, so as to obtain the inner mold 8 of a crank in the injection molding process. Furthermore, the temperature is set at 180° C./190° C./200° C./205° C. in the injection molding process.

Step 2: Covering the inner mold 8 of the crank with a pre-preg carbon fiber material (the part material 41), and disposed the inner mold 8 which is covered with the pre-preg carbon fiber material into a outer metal mold 9 which corresponds thereto for the thermoforming after the covering process is completed; first heating the outer metal mold 9 to 120° C. and keeping the heat for 30 minutes; then heating up the outer metal mold 9 to 150° C. and keeping the heat for 1 hours for the solidification process; and cooling the outer metal mold 9 to form the part material 41.

Step 3: Removing the composite part (the part material 41) from the outer metal mold 9 after the inner mold 8 cools down; drilling respective two 3 mm holes on two sides of the part material 41 (crank) which is formed, and then disposed the inner mold 8 covered with the part material 41 with two 3 mm holes into the mold 90; and melting the inner mold 8 to flow out (demold) of the part material 41 to obtain the hollow part 4 (such as a composite hollow member, hollow crank) after 1 hour heating the mold 90 at 180° C. within a hot oven.

### Second Embodiment

Step 1: Mixing 1.00 kg of the polypropylene (the high crystalline polymeric material 2) with 50.00 g of the paraffin wax (the lubricant material 3) and 200.00 g of the quartz powder (SILIVER BOND 904, as the function filler) and stirring; kneading and granulating the mixture of the polypropylene, the paraffin wax, and the quartz powder in a twin screw pelletizer machine to produce particles; the temperature is set at 170° C./175° C./180° C./185° C./185° C./180° C./175° C. the kneading and granulation process; drying the particles to produce the plurality of thermoplastic fusible particles; and melting the plurality of thermoplastic fusible particles in the injection molding machine 7 and then injecting the plurality of thermoplastic fusible particles which is melted into a mold, so as to obtain the inner mold 8 in the injection molding process. Furthermore, the temperature is set at 180° C./190° C./200° C./205° C. in the injection molding process.

Step 2: Arranging a crude rubber on the inner mold 8; and disposed the inner mold 8 which is covered with the crude rubber (the part material 41) into a outer metal mold 9 which corresponds thereto for the thermoforming after the covering process is completed, first heating the outer metal mold 9 to 130° C. and keeping the heat for 30 minutes; then heating up the outer metal mold 9 to 170° C. and keeping the heat for 1 hours for the vulcanization; and cooling the outer metal mold 9.

Step 3: Removing the inner mold 8 covered with the part material 41 from the outer metal mold 9 after the inner mold 8 cools down, and then disposed the inner mold 8 covered with the part material 41 into the mold 90; and melting the inner mold 8 to flow out (demold) of the part material 41 to obtain the hollow rubber part (the hollow part 4) after 1 hour heating the mold 90 at 200° C. within the hot oven.

In conclusion, the thermoplastic fusible inner mold material has excellent high-temperature fluidity, so as to be melted out from the hollow part which is covered on the product at a predetermined high temperature without adhering any residue substances. And the thermoplastic fusible inner mold material is non-toxic, recycled, easy production, quick forming, environment friendly, easy for mass manufacturing, harmless of employees, and does not irritate the skin, does not release toxic gas during thermal decomposition. Specifically, a viscosity of the thermoplastic fusible inner mold material and a viscosity of the inner mold respectively drop dramatically and melt dramatically at the high temperature which is equal to or higher than the melting point of thermoplastic fusible inner mold material or the inner mold. Thus, the thermoplastic fusible inner mold material and the inner mold respectively have high temperature fluidity and short dissolution time. Furthermore, the thermoplastic fusible inner mold and the inner mold respectively can keep the viscosity under the melting point, thus the thermoplastic fusible inner mold and the inner mold respectively have high thermal stability. When the part material is forming, the inner mold made of the thermoplastic fusible inner mold material has stably viscosity under the melting point. However, the viscosity of the inner mold dramatically reduces at the high temperature, so as to fast flow out of the hollow part which is formed.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A thermoplastic fusible inner mold material, including: a high crystalline polymeric material and a lubricant material, the high crystalline polymeric material mixed with the lubricant material;
wherein the lubricant material is evenly distributed within the high crystalline polymeric material.

2. The thermoplastic fusible inner mold material of claim 1, wherein the high crystalline polymeric material includes at least one of polyethylene terephthalate (PET), polyoxymethylene (POM), polypropylene (PP), polyethylene (PE) and polylactic acid (PLA); and the lubricant material includes at least one of fatty acid, ester, metallic soap, stearic acid, zinc stearate, paraffin wax, hydrocarbon and amides.

3. The thermoplastic fusible inner mold material of claim 2, wherein the high crystalline polymeric material is polypropylene, polyethylene or mixture thereof, and the lubricant material is paraffin wax, amides or mixture thereof.

4. The thermoplastic fusible inner mold material of claim 1, wherein the high crystalline polymeric material is low density polyethylene (LEPD).

5. The thermoplastic fusible inner mold material of claim 1, including 0.20% to 99.80% by weight of the high crystalline polymeric material, and 0.20% to 99.80% by weight of the lubricant material.

6. The thermoplastic fusible inner mold material of claim 1, including 20.00% to 80.00% by weight of the high crystalline polymeric material, and 20.00% to 80.00% by weight of the lubricant material.

7. The thermoplastic fusible inner mold material of claim 1, further including a function filler, the function filler including at least one of quartz powder, thermal conductive powder, foaming agent, reinforcement fiber, aluminium oxide, talc powder and peroxide.

8. The thermoplastic fusible inner mold material of claim 7, including 30.00% to 99.60% by weight of high crystalline polymeric material, 0.20% to 20.00% by weight of the lubricant material, and 0.20% to 60.00% by weight of the function filler.

9. The thermoplastic fusible inner mold material of claim 7, wherein the function filler includes the talc powder, the thermal conductive powder and the aluminium oxide.

10. The thermoplastic fusible inner mold material of claim 1, which is heated and melted at a predetermined temperature, and the predetermined temperature is higher than 100.00° C.

11. The thermoplastic fusible inner mold material of claim 3, including 20.00% to 80.00% by weight of the high crystalline polymeric material, and 20.00% to 80.00% by weight of the lubricant material; wherein the lubricant material is particles; the thermoplastic fusible inner mold material further includes a function filler, the function filler includes quartz powder, thermal conductive powder, foaming agent, reinforcement fiber, aluminium oxide, talc powder and peroxide; the thermoplastic fusible inner mold material is heated and melted at a predetermined temperature, and the predetermined temperature is higher than 100.00° C.; and the thermoplastic fusible inner mold material is a plurality of thermoplastic fusible particles, and the plurality of thermoplastic fusible particles are produced by kneading and granulating mixture of the high crystalline polymeric material and the lubricant material.

12. An inner mold made of the thermoplastic fusible inner mold material of claim 1.

13. The inner mold of claim 12, wherein a melting temperature of the inner mold is higher than 100.00° C.

14. The inner mold of claim 12, which is produced by injecting the thermoplastic fusible inner mold material which is heated and melted into a mold cavity, the inner mold is adapted for being covered with a part material, and a melting point of the inner mold is lower than a melting point of the part material.

15. A method for manufacturing a hollow part by the inner mold of claim 12, including following steps of:
providing the inner mold;
covering the inner mold with a part material;
heating the inner mold which is covered with the part material to form the part material; and
heating the inner mold covered with the part material which is formed at a predetermined temperature to melt the inner mold out of the part material which is formed to form the hollow part;
wherein a melting point of the inner mold is lower than a melting point of the part material.
